(19) United States
(12) Patent Application Publication
(10) Pub. No.: US 2021/0176085 A1
(43) Pub. Date: Jun. 10, 2021

(54) OPEN-LOOP AND/OR CLOSED-LOOP CONTROL OF HOUSEHOLD APPLIANCES

(71) Applicant: Henkel AG & Co. KGaA, Duesseldorf (DE)

(72) Inventors: ARND KESSLER, Monheim am Rhein (DE); LARS ZUECHNER, Langenfeld (DE); ROBERT RUIZ HERNANDEZ, Duesseldorf (DE)

(73) Assignee: Henkel AG & Co. KGaA, Duesseldorf (DE)

(21) Appl. No.: 16/767,543

(22) PCT Filed: Dec. 13, 2018
(86) PCT No.: PCT/EP2018/084707

§ 371 Date: May 27, 2020

(30) Foreign Application Priority Data
Dec. 19, 2017 (DE) 10 2017 223 224.2

(51) Int. Cl. H04L 12/28; G08C 17/02

(52) U.S. Cl. CPC H04L 12/2818; G08C 17/02; H04L 2012/285; G08C 2201/93; G08C 2201/50

(57) ABSTRACT

In particular, a system for the control and/or adjustment of one or several household appliances is disclosed, the system comprising: at least one household appliance; at least one interface device installed in a household, which provides an interface for communication; and at least one server, which provides a service; wherein the at least one household appliance is at least partially controllable and/or adjustable via the at least one interface device and/or via the at least one server. Furthermore, a method for controlling and/or adjusting one or several household appliances, and a device for executing the present method are disclosed.

### CROSS-REFERENCE TO RELATED APPLICATION

This application is a U.S. National-Stage entry under 35 U.S.C. § 371 based on International Application No. PCT/EP2018/084707, filed Dec. 13, 2018, which was published under PCT Article 21(2) and which claims priority to German Application No. 10 2017 223 224.2, filed Dec. 19, 2017, which are all hereby incorporated in their entirety by reference.

### TECHNICAL FIELD

The present disclosure concerns a system for controlling and adjusting one or several household appliances, in particular for controlling and/or adjusting the one or several household appliances.

### BACKGROUND

Systems for the control and adjustment of one or several household appliances, such as washing machines, dishwashers or dryers, are known from the state of the art. The aim in operating such household appliances is typically to achieve a high degree of user-friendliness and at the same time the best possible result (in the case of a washing machine, in particular, a cleaning result that is as spotless as possible and as gentle on the laundry as possible).

If, for example, increased soiling is to be taken into account, a user must take this into account manually, for example, and select an appropriate program or detergent. Approaches are known in which parameters of the household appliance are automatically adjusted in order to achieve the best possible result. For example, parameters of the household appliance are adjusted to parameters defined by the detergent used. For example, the washing program of a washing machine is adjusted to the detergent used or the cleaning program of a dishwasher is adjusted to the dishwashing detergent used.

The disadvantage is that in many situations and scenarios the result to be achieved still needs to be improved.

### BRIEF SUMMARY

Systems and methods for control and/or adjustment of household appliances are provided. In an exemplary embodiment, a system includes a household appliance and an interface device located in a household that provides an interface for communication. A server is also provided. The household appliance is at least partially controllable and/or adjustable via the interface device or the server, where the household appliance is a washing machine, a dryer, a dishwasher, or a mobile appliance that may be placed in the washing machine, the dryer, or the dishwasher.

A method for controlling and/or adjusting a household appliance is provided in another exemplary embodiment. The method includes the steps of obtaining an external information with a server, and generating a control parameter based at least in part on the external information. The control parameter is communicated to an interface device, and the household appliance is controlled based at least in part on the control parameter.

### BRIEF DESCRIPTION OF THE DRAWINGS

The present disclosure will hereinafter be described in conjunction with the following drawing figures, wherein like numerals denote like elements, and:

FIG. 1 illustrates a schematic block diagram of a system according to the first aspect;

FIG. 2 illustrates a schematic diagram of an exemplary embodiment of a device according to the second aspect; and

FIG. 3 illustrates different exemplary embodiments of a storage medium according to the second aspect.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

Against the background of the state of the art presented, the task is thus to variably improve the result to be achieved with a household appliance with regard to the many possible situations and scenarios.

According to a first aspect of the present disclosure, a system for control and/or adjustment of one or several household appliances is described, the system comprising:
at least one household appliance;
at least one interface device located in a household providing an interface for communication; and
at least one server that provides a service;
wherein the at least one household appliance is at least partially controllable and/or adjustable via the at least one interface device and/or via the at least one server.

In particular, the household appliance may be a washing machine, dryer, dishwasher or mobile appliance which may be placed in a washing machine, dryer or dishwasher.

According to a second aspect of the present disclosure, a device is described which is adapted or comprises corresponding features to be part of a system according to the first aspect. Devices of the system according to the first aspect are or comprise in particular one or several devices according to the second aspect.

According to the second aspect of the present disclosure an alternative device is also described, comprising at least one processor and at least one memory with computer program code, wherein the at least one memory and the computer program code are configured to execute and/or control with the at least one processor at least one method performed by a device according to the second aspect. By a processor is meant for example a control unit, a microprocessor, a micro-control unit such as a micro-controller, a digital signal processor (DSP), an application-specific integrated circuit (ASIC) or a field-programmable gate array (FPGA).

For example, an exemplary device further comprises features for storing information such as a program memory and/or a main memory. For example, an exemplary device as contemplated herein further comprises features for receiving and/or transmitting information via a network such as a network interface. For example, exemplary devices as contemplated herein are interconnected and/or connectable via one or several networks.

An exemplary device according to the second aspect is or comprises, for example, data processing equipment which is set up with software and/or hardware to be able to carry out the respective steps of an exemplary process carried out by a device according to the second aspect. Examples of data processing equipment are a computer, a desktop computer, a server, a thin client and/or a portable computer (mobile device), such as a laptop computer, a tablet computer, a wearable, a personal digital assistant or a smartphone.

Individual process steps of the method, which for example are carried out by a device according to the second aspect, may be carried out here with a sensor device, which also includes at least one sensor element. Likewise, individual method steps which, for example, do not necessarily have to be carried out with the sensor device may also be carried out by a further device which is connected in particular via a communication system to the device which includes at least one sensor element.

Further devices may be intended, for example, a server and/or, for example, a part or component of a so-called computer cloud, which provide data processing resources dynamically for different users in a communication system. In particular, a computer cloud is a data processing infrastructure according to the definition of the “National Institute for Standards and Technology”” (NIST) for the term “cloud computing”. An example of a computer cloud is a Microsoft Windows Azure platform.

According to the second aspect of the present disclosure, a computer program is also described which comprises program instructions which cause a processor to execute and/or control a process performed by a device according to the second aspect when the computer program runs on the processor. An exemplary program as contemplated herein may be stored in or on a computer-readable storage medium containing one or several programs.

According to the second aspect of the present disclosure, a computer-readable storage medium containing a computer program according to the second aspect is also described. A computer-readable storage medium may, for example, be a magnetic, electrical, electro-magnetic, optical and/or other storage medium. Such a computer-readable storage medium is preferably tangible (i.e. “touchable”), for example it is designed as a data storage medium device. Such a data storage medium device is for example portable or permanently installed in a device. Examples of such a data storage medium device are volatile or non-volatile random access memories (RAM) such as NOR flash memories or sequential access memories such as NAND flash memories and/or read-only memories (ROM) or read-write memories. Computer-readable shall be understood to mean, for example, that the storage medium may be read and/or written to by a computer or data processing equipment, such as a processor.

In the following, exemplary features and exemplary embodiments are described in more detail according to all aspects:

For example, information may be available on the at least one server that may variably improve a cleaning result to be achieved by the at least one household appliance, e.g. weather information, to name just one non-limiting example. For example, weather information may control and/or adjust the at least one household appliance in such a way that, for example, in the event of an increased pollen count, a cleaning program for a household appliance configured as a washing machine, for example, is controlled and/or adjusted in such a way that particularly intensive cleaning is affected. The above example may, for example, be further extended, whereby, in addition to weather information, for example, individual information about a user controls and/or adjusts the at least one household appliance in such a way that, in addition to weather information, individual information about the user also at least partially influences the control and/or adjustment of the at least one household appliance. If, for example, the individual information indicates that the user is an allergy sufferer and the weather information indicates that an increased pollen count is to be expected, a corresponding cleaning program may be selected, for example, for carrying out the respective cleaning program at the least one household appliance in such a way that the irritation caused by washed laundry due to the pollen count is minimized for the user after cleaning.

In the manner described above, many different types of information that are already regularly available from at least one server providing a service may be taken into account for the control and/or adjustment of the at least one household appliance. Consequently, a control and/or adjustment of the at least one household appliance is at least partially performed by the at least one server providing a service. Alternatively or additionally, the control and/or adjustment is partly performed via the at least one interface device.

For the purposes of the present subject-matter, the expression “whereby the at least one household appliance is at least partially controllable and/or adjustable via the at least one server” means in particular that a control and/or adjustment may be carried out by the at least one server. Furthermore, this wording also means that information is transmitted by the at least one server, e.g. to a user device or a home appliance server located in the household (also referred to as smart home server or smart home system), e.g. following a previous request, and the control and/or adjustment of the at least one household appliance is then performed by the user device or the home appliance server located in the household. Accordingly, direct communication between the at least one household appliance and the at least one server may also take place. Alternatively, indirect communication between the at least one household appliance and the at least one server may take place, for example, via the user appliance and/or the home appliance server located in the household. In particular, the system further comprises at least one user device (e.g. a mobile device, such as a smartphone, tablet, wearable, IoT device, to name but a few non-limiting examples) and/or the home appliance server located in the household.

In this way it is possible to variably improve the result to be achieved with a household appliance with regard to the many possible situations and scenarios, especially by using a lot of existing information for the control and/or adjustment of at least one household appliance. This is realized in particular by the fact that the at least one household appliance may at least be partially controlled and/or adjusted from “different sources”, namely via the at least one interface device and/or via the at least one server.

Communication between the at least one household appliance and the at least one server, and/or between the at least one household appliance and the at least one interface device may, for example, be at least partially wireless and/or wired. Wireless communication may, for example, be based on mobile radio communication (e.g. according to the 2G, GPRS (General Packet Radio Service), 3G, LTE (Long Term Evolution), or future 5G standards), or a short-range communication (e.g. according to BT (Bluetooth), BLE (Bluetooth Low Energy), ZigBee communication, just to name a few non-limiting examples), or on WLAN (Wireless Local Area Network) based communication. Wired communication may be based on LAN (Local Area Network), and/or WAN (Wide Area Network) based communication.

Furthermore, control and/or adjustment of the household appliance may, for example, be carried out in such a way that an input is detected by an input device (e.g. voice input assistant device or the like), is forwarded by the input device to the at least one server, and subsequently control and/or adjustment of the at least one household appliance is carried out via this at least one server at least partially based on the input.

An exemplary embodiment according to all aspects is exemplified in that the at least one household appliance is a mobile appliance and/or a permanently installed household appliance.

The system further comprises, in particular, at least one first household appliance configured as a mobile device and at least one second household appliance configured as a permanently installed household appliance.

The mobile device is, for example, a device which may be variably installed in another household appliance or which may preferably be installed in the at least one household appliance (i.e. in particular in the treatment room of a washing machine or dishwasher). The mobile device comprises, for example, one or several sensors (e.g. accelerometer, conductivity sensor, temperature sensor, or a combination thereof, to name but a few non-limiting examples), one or several containers for storing one or several cleaning and/or care products, and an actuator for dosing the one or several cleaning and/or care products. Furthermore, the mobile device may comprise at least one processor and at least one memory, so that, for example, information acquired by the one or several sensors may be processed and, based on the processed information, an action by the mobile device (e.g. dosing of the one or several cleaning and/or care agents) may be carried out or its execution may be initiated. Optionally, the mobile device may in particular be connected to at least one permanently installed household appliance in a communication-technological connection (e.g. wireless communication according to a short-range standard (e.g. Bluetooth, Bluetooth Low Energy, ZigBee, or a combination thereof, to name only a few non-limiting examples), and/or according to a WLAN (Wireless Local Area Network) standard. Alternatively or additionally, an action may be performed or initiated by the mobile device based on a received control parameter.

The mobile device is or comprises, for example, a dosing device which is designed to dose a substance (in particular a cleaning and/or care product) to the at least one household appliance or into a treatment room thereof. The dosing device may be contained in the mobile device, or it may be a separate device in communication with the at least one household appliance, into which the mobile device is or may be installed, the mobile device and/or a remote server (e.g. via a communication network, such as the Internet) (e.g. to receive the external information).

The fixed household appliance is for example a laundry treatment machine (in particular a tumble dryer, mangle or washing machine) and/or a cleaning machine (in particular a washing machine or dishwasher). However, the term household appliance shall not necessarily mean a device for private use. On the contrary, the term household appliance may also include equipment for professional kitchens or dry-cleaning operations and/or laundry treatment and cleaning machines. In the case of such household appliances, the (cleaning) result to be achieved and/or the user-friendliness may be improved in a particularly advantageous manner with the system described.

In general, however, a household appliance may also be understood to be a device such as a food processor, coffee machine or vacuum cleaner (in particular a vacuum robot), where the described method may also be used advantageously to improve the work result in a user-friendly manner.

If the at least one household appliance is in particular a cleaning machine such as a washing machine or dishwasher, such a household appliance will usually use a cleaning and/or maintenance product. This includes not only detergents, but also, in particular, fabric softeners, machine cleaners, dishwashing detergents, water softeners, rinse aids, starch, vinegar cleaners, water repellents, color catchers, bleaching agents, graying inhibitors, color transfer inhibitors and/or biologically active systems.

A further exemplary embodiment according to all aspects stipulates that the at least one interface device provides a connection between the at least one household appliance, in particular further appliances located in the household, and the at least one server, in particular further external devices (e.g. on the Internet).

For example, the interface device provides an interface between at least two entities (e.g. the at least one household appliance and the at least one server). The interface device also provides an interface to connect two entities, each of which is connected to a different communication network, so that in particular (bi-) directional communication between the at least two entities is possible. It is understood that further entities may also be connected via the interface device to the at least one household appliance and/or the at least one server.

For example, the at least one server is connected to the Internet. For example, the at least one household appliance is connected to an LAN, or a local area communication network (e.g. BT, BLE, ZigBee communication network, or the like), to name but a few non-limiting examples. The interface device comprises, for example, at least one communication interface which is configured and/or adapted to communicate with the Internet and at least one further communication interface which is configured and/or adapted to communicate with the communication network via which the at least one household appliance is connected to the interface device.

In an exemplary embodiment according to all aspects, the at least one interface device comprises at least one first transceiver for communication with the at least one household appliance (e.g. according to the BT, BLE, WLAN standard) and at least one second transceiver for communication with the at least one server (e.g. according to the mobile communication (2G, GPRS, 3G, LTE, 5G) standard).

The at least one first transceiver is, for example, included in a communication interface included in the interface device. For example, the second transceiver is also included in the communication interface included in the interface device. Alternatively, the second transceiver is included, for example, in a further communication interface included in the interface device.

In a further exemplary embodiment according to all aspects, the interface device is included in or electrically connected to at least one household appliance.

In a further exemplary embodiment according to all aspects, the at least one household appliance comprises at least one wired and/or wireless communication interface for communicating with further household appliances and/or for communicating with the at least one interface device.

The interface device is, for example, a router. Such a router may, for example, be comprised by the at least one domestic appliance, e.g. be part of the at least one domestic appliance, or alternatively be connected to the at least one domestic appliance, e.g. via a wired (e.g. according to the LAN standard) and/or via a wireless communication connection (e.g. according to the BT, BLE, ZigBee, and/or WLAN standard), to name only a few non-limiting examples. Alternatively or in addition, the interface device is for example an NB-IoT (Narrow Band Internet-of-Things) device.

In the case that several household appliances are included in the system according to the first aspect, these several household appliances may, for example, each include a corresponding interface device. This does not preclude the inclusion of a further dedicated interface device, i.e. one not included in the plurality of household appliances.

For example, one of the interface devices included in the multiple household appliances or the (dedicated) interface device may, in the manner of a master/slave principle, communicate with a specific communication network (e.g. the Internet). This may be, for example, the one of the several interface devices or the (dedicated) interface device having the best connection (e.g. best reception, lowest signal-to-noise ratio, or other parameters specifying the (communication) connection) to the communication network. It may also be that the interface devices that are able to establish a communication link, or has an established communication link, for example, with all entities located in the household (e.g. household appliances, user equipment, input assistance equipment, home appliance server, or a combination thereof, to name but a few non-limiting examples). This is limited, for example, by space constraints in the event that a wireless communication link is used.

A further exemplary embodiment according to all aspects is that the at least one server providing the one service provides one or several items of external information.

The at least one server features, for example, as mentioned above, a communication link with one or several of the appliances located in the household (e.g. the at least one household appliance, e.g. via the interface device). For example, one of the one or several external items of information is representative of at least one external given condition outside the at least one household appliance. Such a control and/or adjustment may be carried out at least partially based on the one or several items of external information which may be transmitted, for example, to the household, in particular to the at least one household appliance, and/or to a user appliance, and/or a home appliance server. The at least one household appliance, and/or the user appliance, and/or the home appliance server may process (e.g. analyze and/or evaluate) such external information and take the one or several external items of information at least partially into account, for example, when determining a control parameter for the control and/or adjustment of the at least one household appliance.

For example, one of the one or several external items of information is representative of at least one external given condition. External information representative of at least one external given condition is understood to be information which does not directly concern or is not representative of the internal operation of at least one household appliance. External information is therefore not (internal) information which typically (exclusively) exemplifies the at least one household appliance in question or the process carried out with it, but which is typically present, determined and/or available independently of the at least one household appliance. To give an example, in the case of a washing machine as at least one household appliance, the external information is not representative of the detergent or washing program used. Rather, the external information is representative of one or several factors or circumstances outside the household appliance that are not directly related to it.

An external given condition outside the at least one household appliance is, for example, a “surroundings condition”, in particular a condition that exists or manifests itself in the apartment or house (the household) in which the household appliance is located. The external given condition may thus be a local condition in the surroundings of the at least one household appliance (for example a few meters), such as a room temperature. However, an external given condition may also be a situation outside closed areas or outdoors, such as a (local) weather condition. The external given condition does not necessarily have to be an environmental condition, but can also be an “activity condition”, which is particularly related to the user of the at least one household appliance, such as an activity of the user. Such external information, which is represented by an activity condition, may be stored in a user profile, for example. Further details of the user profile are explained in more detail below in this description.

The one or several external items of information may be in the form of digital data, for example. Since one of the one or several items of external information need only be representative of the external given condition, this external information does not need to describe the external given condition completely. The respective external information of the one or several items of external information may also comprise or include only one item of information from which the external given condition may be derived

The respective external information of the one or several items of external information may, if required, also be representative of several external given conditions outside the at least one household appliance, which may then be taken into account in part or in full in the control and/or adjustment of the at least one household appliance.

The respective external information of the one or several items of external information may be obtained, for example, by receiving the external information at a communication interface of an entity (e.g. the at least one household appliance, the user appliance, the home appliance server, just to name a few non-limiting examples), for example via a (communication) network such as the Internet, a wired network and/or a wireless network, the external information being provided, for example, by the interface device, so that the communication interface of the entity may receive the respective external information of the one or several items of external information.

In an example, the respective external information of the one or several items of external information is received by a (remote) server. For example, if the external information of the one or several items of external information is representative of an external given condition concerning the weather, the external information may be received from a server providing weather data.

An exemplary embodiment according to all aspects is exemplified in that data may be transmitted from the at least one server to the at least one household appliance.

An exemplary embodiment according to all aspects is exemplified in that respective external information of the one or several items of external information is obtained by an automated or automatic reception of this respective item of external information.

Particularly preferred is the receipt of the respective external information of the one or several items of external information as an automated or automatic receipt of this external information. This means that the user does not need to provide or enter the external information manually (for example, using an input device of a user interface).

The service provided by the at least one server may, for example, be provided for one or several further households and/or household appliances, or the service may, for example, also be usable for applications outside the household or the at least one household appliance. For example, the service may be provided as part of a so-called app and/or via a browser application (e.g. providing weather data, to name but one non-limiting example). In particular, the service provided by the at least one server is regularly offered or provided not exclusively for the control and/or adjustment of at least one household appliance, in this case the at least one household appliance.

A further exemplary embodiment in all aspects is exemplified in that the service provided by the at least one server is a cloud service.

Such cloud services are provided, for example, under the designations “BSH Cloud”, “Alexa Cloud”, “PLUME Cloud”, “Henkel Cloud”, “Smarthome Cloud”, to name but a few non-limiting examples.

The cloud service is exemplified by the fact that the cloud service stores and synchronizes data for a large number of different users, so that the data may be used by one or several entities. Furthermore, the cloud service may provide different services, such as storing user-specific information, aggregating information of different users, or similar services for the large number of users. The services may increase user convenience, for example, because information is available on different entities (of the user) without any user intervention. For example, the at least one household appliance may store status information representative of, for example, the progress of a washing or cleaning program performed by the at least one household appliance. The user may then query this status, for example from his user equipment. It is understood that the use of the cloud service is not limited to the rendering of information.

In a further exemplary embodiment according to all aspects, the system further includes:

at least one user device and/or at least one input assistance device;

wherein said at least one user device and/or said at least one input assistant device communicates (e.g. via said at least one interface device) with said at least one home appliance and/or with said at least one server.

The at least one user device is, for example, a mobile device (e.g. smartphone, tablet, wearable, IoT (Internet-of-Things) device, just to name a few non-limiting examples). For example, the user device is portable, weighing less than about 5, 4, 3, 2, or 1 kg.

Alternatively or additionally, there is, for example, a direct communication between the at least one user device and/or the at least one input assistance device. The at least one user device and/or the at least one input assistant device comprise, for example, one transceiver each for the corresponding communication.

The at least one input assistant device is, for example, a voice input assistant device, such as the product sold under the name Alexa, a home appliance server (such as a smart home system, or a combination thereof, to name but a few non-limiting examples). The speech input assistant device may, for example, perform an acquisition of at least one voice command indicative of at least one parameter on the basis of which at least partial control and/or adjustment of the at least one home appliance may be performed.

The voice command may, for example, be entered by a user, e.g. via a voice communication interface (e.g. an electronic device comprising a microphone or the like). The voice command entered may be processed locally by the voice communication interface or by a server. For processing by a server, the voice command may, for example, be transmitted to a server via a communication connection of the electronic device after the input. Using speech recognition software, the voice command entered may be processed, for example. This may require the installation of additional software. A voice command processed in this way may, for example, be converted into a control parameter that the user device and/or the at least one household appliance may, for example, evaluate, process, forward or use in any other way.

A further exemplary embodiment according to all aspects is exemplified in that on the part of the at least one user device, on the part of the at least one input assistant device, and/or on the part of the at least one household device, data may be acquired by the at least one server (e.g. by employing a request transmitted to the server), and at least one control parameter for the at least one household appliance and/or for at least one further household appliance may be generated at least partially based on the data acquired from the at least one server, and a control and/or adjustment of the at least one household appliance and/or of the at least one further household appliance may be initiated (e.g. output to the at least one household appliance and/or to the user appliance) at least partially based on the generated control parameter.

Accordingly, the control parameter may be generated by the user device, if included in the system in question, for at least one household appliance. Alternatively or additionally, the control parameter may be generated, for example, by the at least one household appliance for control and/or adjustment for itself. Alternatively or additionally, the control parameter may be generated by the at least one household appliance for a further household appliance included in the system in question. In each case, a control and/or adjustment of the at least one household appliance and/or a further household appliance included in the present system may be carried out at least partially based on the generated control parameter.

In an exemplary embodiment according to all aspects, the control parameter may furthermore be generated at least partially based on a user input and/or on information stored in a user profile.

The user profile includes, for example, information indicative of a particular characteristic and/or typical habits of the user, e.g. on which days of the week the user does sports, when the user comes home from work, what and/or when the user cooks, just to name a few non-limiting examples. At least partly based on external information, which may also be taken from the user profile, for example, and which is indicative of a particular characteristic and/or typical habits of the user, a control and/or adjustment of at least one household appliance may be carried out. If, for example, the external information indicates that the user has previously done sports, a washing program may be selected to carry out the laundry, for example, which carries out particularly intensive cleaning.

In a further exemplary embodiment according to all aspects, the user input and/or the information stored in the user profile may be used for unsupervised learning and/or calibration of consumer products related to the at least one household appliance.

For example, the unsupervised learning and/or calibration may also be carried out by employing machine learning.

To give an example, based on consumption information obtained, for example, from one or several cycles performed on at least one household appliance, the level of detergent and/or maintenance product in stock may be determined. This may be done, for example, by aggregating a first item of information (e.g. an external item of information) indicative of a count of the cycles, with a second item of information (e.g. a further external item of information) indicative of an amount of dosage taken. Subsequently, it may, for example, be acquired by employing calibration when further cleaning and/or care products must be procured. Corresponding information may then be output, e.g. to the at least one household appliance and/or to the user device. In addition, an order process for the additional cleaning and/or care product may be initiated, for example. In order to show a further option, information (e.g. stored in the user profile) may be taken into account, e.g. how often or when the user typically uses the at least one household appliance. In accordance with a household appliance designed as a washing machine, the user profile may, for example, contain information on when the user typically washes (e.g. on which day of the week). Now, before triggering an order process for ordering depleted cleaning and/or care products, for example, external information representing the required delivery time may be considered, so that, for example, the order process is triggered in time, so that, in particular, before the information included in the user profile, which represents a weekday (and/or time) on which (and/or at which) the user typically uses the at least one household appliance, the ordered cleaning and/or care product reaches the user in time. The above example is indicative of an exemplary aggregation of external information with information covered e.g. by the user profile and is non-limiting for the present subject-matter.

In accordance with another preferred embodiment of the method, the method also involves requesting and/or receiving information representative of the quality (e.g. user satisfaction) of the result achieved by the household device. Receiving this information may be automated (for example, by the household device). This may be done, for example, by employing sensors (e.g. optical sensors to detect the result, in the case of a washing machine, for example, sensors to detect the degree of soiling of the laundry or rinse water). Alternatively or in addition, this information may also be requested from the user (for example, by the household appliance or a separate device such as a smartphone) afterwards. In an example, the information may be included in the user profile in a way that is representative of the quality of the result achieved by the operation.

On the basis of the information obtained representative of the quality of the result obtained by the at least one household appliance and/or by recording used parameters of the at least one household appliance (in the case of a washing machine, for example, the amount of detergent composition to be dosed, the short bath ratio, the temperature, the duration, the amount of water, the speed of rotation, etc.), it is possible to optimize the operation of the at least one household appliance according to the external given conditions.

Especially in this context, it is possible that the optimization of the operation of at least one household appliance includes machine learning or is based on it, so that for a given external given condition the highest possible quality of the achieved result is reached. Machine learning is understood to mean that an artificial system (for example a device according to the second aspect) learns from examples and can generalize these after the learning phase is completed. This means that the examples are not simply learned by heart, but patterns and regularities in the learning data are recognized. Different approaches may be taken to this end. For example, supervised learning, partially supervised learning, unsupervised learning, reinforced learning and/or active learning may be used, especially in connection with a deep learning method. Supervised learning may, for example, be performed by employing an artificial neural network (such as a recurrent neural network) or by employing a support vector machine. Unsupervised learning may also be performed by employing an artificial neural network (e.g. an auto encoder). The learning data is then used, for example, in particular as the (repeatedly) received information representative of the quality of the achieved result, the external information representative for an externally given condition outside the at least one household appliance and/or the used parameters of the at least one household appliance.

A further exemplary embodiment according to all aspects is exemplified in that the generated control parameter at least partially represents one of the following actions i) to viii):

i) switching on or off the at least one household appliance;
ii) changing or exchanging a cleaning, drying and/or maintenance program of the at least one household appliance;
iii) requesting a status of the at least one household appliance;
iv) requesting a status of a cleaning, drying and/or maintenance program of the at least one household appliance;
v) external use of the communication interface included in or connected to the at least one household appliance;
vi) safety-related intervention in the function of the at least one domestic appliance;
vii) causing the output of information by the at least one household appliance; and
viii) requests for information from one or several sensors included in at least one household appliance.

The generated control parameter represents at least partially one of the actions i) to viii). This includes in particular that the generated control parameter may also include more than one of the actions i) to viii), e.g. action i) and action ii). Furthermore, this includes that the generated control parameter may, in addition to at least one of actions i) to viii) (i.e. even more than one of actions i) to viii)), also represent further information on the basis of which the at least one household appliance may be controlled and/or adjusted.

Control and/or adjustment of the at least one household appliance, taking into account the external information received, is therefore particularly preferred by influencing these actions.

With regard to switching on and/or off the at least one household appliance, it may be influenced, for example, whether (in particular at all) the at least one household appliance is switched on and/or off and/or at what time (e.g. time, date) the at least one household appliance is switched on and/or off. As mentioned above, switching on and/or off may preferably be influenced based on an external given condition, which is a geographical location of the at least one household appliance and/or the user, but also, for example, based on a weather-related external given condition.

Influencing the selection, composition and/or dosing of a cleaning agent to be used for the at least one household appliance may be carried out by different actions. For example, the amount to be dosed (the amount of detergent in the case of a washing machine or the amount of rinse aid in the case of a dishwasher), the dosing time, the product to be dosed or individual ingredients (for example soil release polymers, bleaching agents, enzymes, hygiene rinse aid in the case of a washing machine) or combinations thereof may be influenced. In addition, the compatibility of combinations of ingredients may be taken into account to avoid incompatibility (e.g. bleaching agents and enzymes).

Influencing the operating mode of at least one household appliance may, for example, include selecting a certain (preset) program, running additional programs, influencing (extending or shortening) the program duration, changing individual parameters of the program (in the case of a washing machine, for example, the temperature, spin speed, etc.) or loading or exchanging the entire program or program sections on the household appliance.

In addition, it is possible that not only the control and/or adjustment of the at least one household appliance is (automated) carried out taking into account the external information received, but also that a recommendation is given to the user. In this way it is possible, for example, that in addition to an automated adjustment of the at least one household appliance, manual pretreatment (e.g. of clothing, dishes or floor) may also be necessary. Such a recommendation may then be displayed for the user by employing, for example, the user device.

Furthermore, at least one household appliance may output at least one item of output information or initiate its output. For example, the at least one item of output information may be output to the user device, the Home Appliance Server, and/or to the at least one server (e.g. for storing the output information in the user profile or associated with the user profile), to name only a few non-limiting examples.

The at least one item of output information is, for example, representative of a feedback concerning information from the at least one household appliance to the user. For example, a status of the at least one household appliance (e.g. concerning information determined by the at least one household appliance, e.g. whether there is a defect, what step of a cleaning program is currently being performed by the at least one household appliance (e.g. rinsing, water intake, washing, or other steps to be or have been performed by the cleaning program, which cleaning and/or care product is being dispensed, an effected switching on or off of the at least one household appliance, a change of a cleaning program of the at least one household appliance, a status of a cleaning program of the at least one household appliance, or a combination thereof, to name only some non-limiting examples).

The at least one item of output information represents, for example, information that is directly related to the at least one household appliance. For example, the at least one item of output information may represent a location (or position) of the at least one household appliance, e.g. whether the at least one household appliance is located in the household, and/or whether the at least one household appliance is located in or outside a treatment room of another household appliance (e.g. washing machine, dryer, dishwasher, to name but a few non-limiting examples), and/or within a treatment room of which household appliance included in the household the at least one household appliance (e.g. a mobile appliance, such as a dosing device) is located. Furthermore, the output information may, for example, represent a safety-critical parameter of the at least one household appliance, such as whether a closing device (e.g. door) of the at least one household appliance is opened, whether a water connection is connected to the at least one household appliance, a charging status of a battery (e.g. a rechargeable battery) included in the at least one household appliance, a filling status of one or several stocked cleaning and/or maintenance agents, or a combination thereof, to mention only some non-limiting examples. Furthermore, the output information may represent, for example, an alarm of the at least one household appliance, which may be signaled accordingly by the output of the at least one item of output information to the user, e.g. via the user appliance. The alarm may be indicative of, for example, a treatment room of the at least one household appliance that is not emptied (e.g. laundry has been “forgotten” in the washing machine), a bad smell present in the vicinity of the at least one household appliance, or a combination of these, to name but a few non-limiting examples.

In the case that the system in question comprises a mobile device (e.g. dosing device) as a first household appliance, and a fixed household appliance, e.g. a washing machine, as a second household appliance, wherein the mobile device may be installed in a treatment room of the fixed household appliance, e.g. for dosing of cleaning and/or care agent, at least partly based on sensors (e.g. sensors for the dosing of cleaning and/or care agent) included in the mobile device, e.g. accelerometer, conductivity sensor, optical sensor, or a combination thereof, to name only a few non-limiting examples), the first and the second household appliance may for instance be switched on or off essentially simultaneously, e.g. based on the generated control parameter. In addition, the sensors included in the first household appliance (mobile device) may be used to detect, for example, the degree of contamination of products to be cleaned (e.g. laundry) placed in the treatment room of the second household appliance, or the degree of loading of the treatment room with products to be cleaned, or a combination of these. Corresponding output information may, for example, output as output information the information collected by the first household appliance by employing the sensors (or a sensor, or one of the sensors) or cause it to be output. For example, the output information may represent information collected by the sensor(s) of the first household appliance.

A further exemplary embodiment according to all aspects is exemplified in that by employing the at least one user device and/or the at least one input assistant device, input information may be acquired and/or output information may be rendered.

For example, the input information may be gathered using a touch-sensitive display. The touch-sensitive display may also be used to output information (optical information). In addition, the input information may also be gathered by employing a microphone and/or a keyboard, for example. Acoustic information may be reproduced by employing a loudspeaker, for example. The microphone, the keyboard and/or the loudspeaker are included in the at least one user device and/or that of the at least one input assistant device, or may be connected to the at least one user device and/or that of the at least one input assistant device.

The exemplary embodiments of the present disclosure described above in this description shall also be understood in all combinations with one another. In particular, exemplary embodiments shall be understood in terms of the different aspects disclosed.

In particular, the preceding or following description of method steps according to preferred embodiments of a method should also reveal corresponding features for carrying out the method steps by preferred embodiments of a device. Likewise, by the disclosure of employing a device for carrying out a method step, the corresponding method step should also be disclosed.

Further advantageous exemplary embodiments of the present disclosure are to be found in the following detailed description of some exemplary embodiments of the present disclosure, especially in connection with the Figures. However, the Figures are only intended to clarify, but not to determine the scope of protection of the present disclosure. The Figures are not to scale and are merely intended to illustrate the general concept of the present disclosure. In particular, features contained in the Figures are not intended to be considered as a necessary part of the present disclosure.

As mentioned above, the drawings show

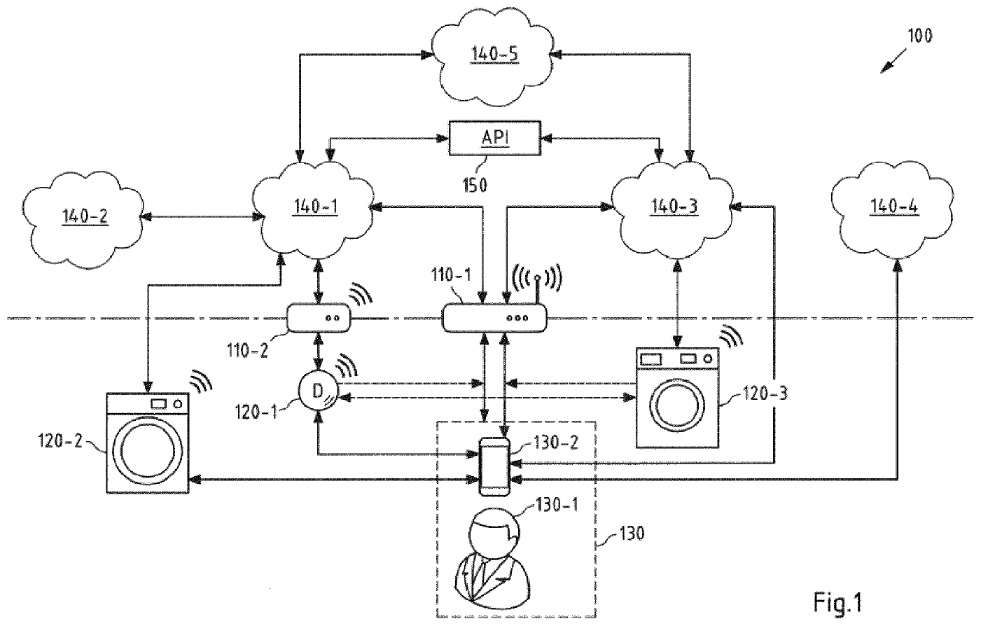

FIG. 1 a schematic block diagram of a system according to the first aspect;

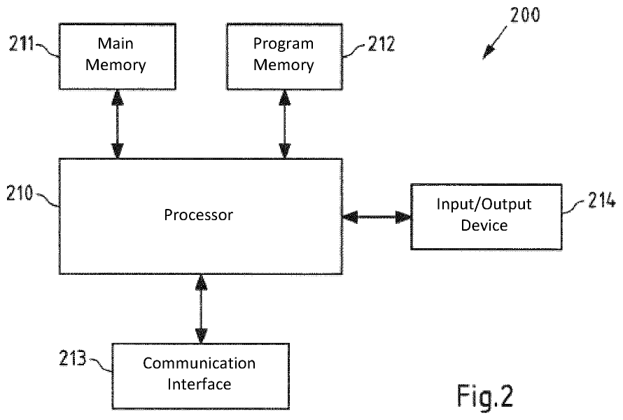

FIG. 2 a schematic diagram of an exemplary embodiment of a device according to the second aspect;

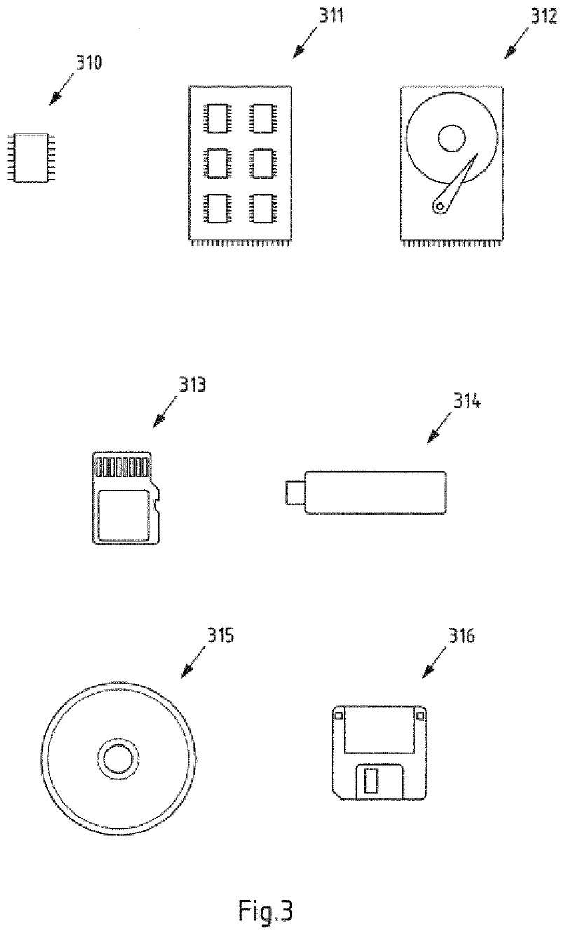

FIG. 3 different exemplary embodiments of a storage medium according to the second aspect.

The following description serves for a deeper understanding of the present subject-matter and should be understood as complementing the above general description and the detailed description should be read together with it.

FIG. 1 shows a schematic block diagram on a high (abstract) level of a system 100 according to the first aspect of the present subject-matter.

System 100 comprises a household which includes that part of system 100 which is located below the dot-dash-line, and system 100 comprises an external part of system 100 which is located above the dot-dash-line.

System 100 currently comprises five servers 140-1 to 140-5, each of which provides a service, an optional API (Application Programming Interface) 150, via which, for example, the services provided by the servers 140-1 to 140-5 may be accessed, two interface devices 110-1 and 110-2, which may provide a connection between the household (lower part of system 100) and the external part of system 100 (upper part of system 100). In addition, system 100 comprises three household devices 120-1 to 120-3, and one user device 130-2 from a user 130-1.

Interface device 110-1, for example, is a router that may connect to one or several of the servers 140-1 to 140-5, e.g. via the Internet. Interface device 110-2 is, for example, an NB (Narrow Band) IoT device which, for example, receives information (e.g. output information) received from at least one household appliance via a short-range communication interface configured, for example, according to a BT, BLE, ZigBee and/or NFC standard and may forward it via a further interface configured, for example, according to a LAN and/or WLAN standard, for example via the Internet to one or several of the servers 140-1 to 140-5.

Servers 140-1 to 140-5, for example, each provide one service (e.g. cloud storage, e.g. for storing one or several user profiles). API 150 may be used, for example, to access the services provided by each of the servers 140-1 to 140-5. It is understood that a dedicated API 150 (not shown in FIG. 1) may be used for each of the services provided by servers 140-1 to 140-5.

User device 130-2 is, for example, a user's smartphone, tablet, or wearable. The user may also use several such user devices in the system in question in all aspects, even simultaneously (not shown in FIG. 1).

The household appliances 120-1 to 120-3 included in system 100 are configured as follows: household appliance 120-1 is a mobile appliance, wherein the mobile appliance 120-1 is installable in a treatment room of a permanently installed household appliance, in this case washing machine 120-3, and/or laundry dryer 120-2, e.g. for dosing of cleaning and/or care agents at least partially based on sensors (e.g. accelerometer, conductivity sensor, optical sensor, or a combination thereof, to name only a few non-limiting examples) in the mobile appliance.

According to exemplary embodiments of the present subject-matter, external information may be obtained, e.g. via the Internet, e.g. via access using the corresponding API 150, representing for example weather data, air pollution data, water hardness data, or a combination thereof. This obtained information may optionally be lodged by a service provided by one of the servers 140-1 to 140-5 (e.g. a cloud service for storing information in a user profile, e.g. server 140-1).

Subsequently, user device 130-2 may, for example, make a request to use washing machine 120-3, after which server 140-1 requests information from the stored user profile and transmits it to the user device (e.g. via interface 110-2). User device 130-2 may at least partially generate a control parameter on the basis of the information received, which causes washing machine 120-3 to perform a control and/or adjustment, i.e. to execute a cleaning program. When generating the control parameter, all of the information stored in the user profile may be taken into account, whereby, for example, further knowledge, e.g. the need for particularly intensive cleaning, may be gained from the available information. Accordingly, the control parameter may then initiate suitable cleaning by washing machine 120-3.

The double arrows used in FIG. 1 should be understood as allowing bidirectional communication between system 100 entities connected by the double arrows. In addition to the connection represented by the double arrows, further, especially indirect connections (e.g. via one of the interface devices 110-1 and 110-2) between the entities of system 100 are possible.

FIG. 2 shows a block diagram of an exemplary embodiment of a device 200, which may in particular carry out an exemplary method according to the first aspect. For example, device 200 is a fixture according to the second aspect.

Device 200 may, for example, be a computer, a desktop computer, a server, a thin client or a portable computer (mobile device), such as a laptop computer, a tablet computer, a personal digital assistant (PDA) or a smartphone. For example, the device may perform the function of a server or a client. For example, device 200 represents user device 130-2 according to FIG. 1, and/or is comprised of a household device 120-1 to 120-3 according to FIG. 1, or represents one of the interface devices 110-1 or 110-2 according to FIG. 1. Accordingly, system 100 according to FIG. 1 may comprise several of the devices 200. For example, device 200 may further represent a Home Appliance Server as described above in the general description of some exemplary designs.

Processor 210 of device 200 is designed in particular as a microprocessor, micro-controller, micro-processing unit, digital signal processor (DSP), application-specific integrated circuit (ASIC) or field-programmable gate array (FPGA).

Processor 210 executes program instructions which are stored in program memory 212 and stores, for example, intermediate results or the like in working or main memory 211. For example, program memory 212 is a non-volatile memory such as a flash memory, a magnetic memory, an EEPROM memory (electrically erasable programmable read-only memory) and/or an optical memory. Main memory 211 is for example a volatile or non-volatile memory, in particular a random access memory (RAM) such as a static RAM memory (SRAM), a dynamic RAM memory (DRAM), a ferro-electric RAM memory (FeRAM) and/or a magnetic RAM memory (MRAM).

Program memory 212 is preferably a local data storage medium permanently connected to device 200. Data storage media permanently connected to device 200 are, for example, hard disks that are integrated in device 200. Alternatively, the data storage medium may also be, for example, a data storage medium that is detachably connected to device 200, such as a memory stick, a removable data storage medium, a portable hard disk, a CD, a DVD and/or a floppy disk.

Program memory 212 contains, for example, the operating system of device 200, which is at least partially loaded into main memory 211 when device 200 is started and is executed by processor 210. In particular, when device 200 is started, at least part of the core of the operating system is loaded into main memory 211 and executed by processor 210. The operating system of device 200 is for example a Windows, UNIX, Linux, Android, Apple iOS and/or MAC operating system.

The operating system allows in particular the use of device 200 for data processing. For example, it manages resources such as main memory 211 and program memory 212, communication interface 213, input and output device 214, provides basic functions to other programs through programming interfaces and controls the execution of programs.

Processor 210 controls communication interface 213, which may be, for example, a network interface, a network card, a network module and/or a modem. Communication interface 213 is set up in particular to establish a connection between device 200 and other devices, in particular via a (wireless) communication system, for example a network, and to communicate with these devices. Communication interface 213 may, for example, receive data (via the communication system) and forward the data to processor 210 and/or receive data from processor 210 and send the data (via the communication system). Examples of a communication system are a local area network (LAN), a wide area network (WAN), a wireless network (e.g. according to the IEEE 802.11 standard, the Bluetooth (LE) standard and/or the NFC standard), a wired network, a mobile network, a telephone network and/or the Internet.

Furthermore, processor 210 may control at least one input/output device 214. Input/output device 214 is, for example, a keyboard, a mouse, a display unit, a microphone, a touch-sensitive display unit, a loudspeaker, a reader, a drive and/or a camera. For example, input/output device 214 may receive input from a user and forward it to processor 210 and/or receive and output information for the user from processor 210.

Finally, FIG. 3 shows different examples of storage media on which an example of the execution of a computer program as contemplated herein may be stored. The storage medium may, for example, be a magnetic, electrical, optical and/or other storage medium. The storage medium may be, for example, part of a processor (e.g., processor 210 in FIG. 2), for example, a (non-volatile or volatile) program memory of the processor or a part thereof (such as program memory 212 in FIG. 2). Exemplary embodiments of a storage medium are a flash memory 310, an SSD hard disk 311, a magnetic hard disk 312, a memory card 313, a memory stick 314 (e.g. a USB stick), a CD-ROM or DVD 315 or a floppy disk 316.

The exemplary embodiments of the present disclosure described in this specification and the optional features and characteristics mentioned in each case shall also be understood as disclosed in all combinations with each other. In particular, unless explicitly stated otherwise, the description of a feature included in an example shall not be understood in the present case to mean that the feature is indispensable or essential for the function of the example. The sequence of the method steps described in this specification in the individual flowcharts is not mandatory; alternative sequences of method steps are conceivable. The method steps may be implemented in various ways, for example, implementation in software (by program instructions), hardware or a combination of both to implement the method steps is conceivable.

Terms used in the Claims such as “comprise”, “have”, “include”, “contain” and the like do not exclude further elements or steps. The expression “at least partially” covers both the “partially” case and the “entirely” case. The wording “and/or” should be understood to mean that both the alternative and the combination should be disclosed, i.e. “A and/or B” means “(A) or (B) or (A and B)”. The use of the indefinite article does not exclude a plural. A single device may perform the functions of several units or devices mentioned in the Claims. Reference signs indicated in the Claims are not to be regarded as limitations of the features and steps used.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A system for the control and/or adjustment of one or several household appliances, comprising:
at least one household appliance;
at least one interface device located in a household providing an interface for communication; and
at least one server that provides a service;
wherein the at least one household appliance is at least partially controllable and/or adjustable via the at least one interface device and/or via the at least one server, wherein the household appliance is a washing machine, a dryer, a dishwasher or a mobile appliance which may be placed in the washing machine, the dryer, or the dishwasher.

2. The system according to claim 1, wherein the at least one household appliance is the mobile appliance.

3. The system according to claim 1, wherein the at least one interface device provides a connection between the at least one household appliance, and the at least one server.

4. The system according to claim 1, wherein the interface device comprises at least one first transceiver for communication with the at least one household appliance and at least one second transceiver for communication with the at least one server.

5. The system according to claim 1, wherein the at least one interface device is electrically connected to the at least one household appliance.

6. The system according to claim 1, wherein the at least one server providing the service provides one or several items of external information.

7. The system according to claim 6, wherein a respective item of external information of the one or several items of external information is obtained by an automated or automatic reception of the respective item of external information.

8. The system according to claim 1, wherein the service provided by the at least one server is a cloud service.

9. The system according to claim 1, wherein the at least one household appliance comprises at least one wired and/or wireless communication interface for communication with further household appliances and/or for communication with the at least one interface device.

10. The system according to claim 9, further comprising:
at least one user device and/or at least one input assistance device;
wherein the at least one user device and/or the at least one input assistant device communicates with the at least one household appliance and/or the at least one server.

11. The system according to claim 1, wherein data may be transmitted from the at least one server to the at least one household appliance.

12. The system according to claim 10, wherein data may be acquired by the at least one server from the at least one user device, from the at least one input assistant device and/or from the at least one household appliance, and at least one control parameter for the at least one household appliance and/or for the at least one further household appliance is at least partially based on the data acquired from the at least one server, and a control and/or adjustment of the at least one household appliance and/or of the at least one further household appliance may be initiated at least partially based on the at least one control parameter.

13. The system according to claim 12, wherein the at least one control parameter may also be generated at least partially based on a user input and/or information stored in a user profile.

14. The system according to claim 13, wherein the user input and/or the information stored in the user profile may be used for unsupervised learning and/or calibration of consumer goods associated with the at least one household appliance.

15. The system according to claim 12, wherein the at least one control parameter represents at least one of the following actions i) to viii):
i) switching on or off the at least one household appliance;
ii) changing or exchanging a cleaning, drying and/or maintenance program of the at least one household appliance;
iii) requesting a status of the at least one household appliance;
iv) requesting a status of a cleaning, drying and/or maintenance program of the at least one household appliance;
v) external use of the at least one wired and/or wireless communication interface included in or connected to the at least one household appliance;
vi) safety-related intervention in the function of the at least one household appliance;
vii) causing the output of information by the at least one household appliance; and
viii) requesting information collected by one or several sensors, wherein the at least one household appliance comprises the one or several sensors.

16. The system according to claim 10, wherein input information may be acquired and/or output information may be rendered by means of the at least one user device and/or the at least one input assistant device.

17. A method of controlling and/or adjusting a household appliance, the method comprising the steps of:
obtaining an external information with a server;
generating a control parameter based at least in part on the external information;
communicating the control parameter to an interface device; and
controlling operation of the household appliance based at least in part on the control parameter.

18. The method of claim 17, wherein controlling operation of the household appliance comprises at least one of actions i) to vii):
i) switching on or off the household appliance;
ii) changing or exchanging a cleaning, drying and/or maintenance program of the household appliance;
iii) requesting a status of the household appliance;
iv) requesting a status of a cleaning, drying and/or maintenance program of the household appliance;
v) externally using a wired and/or wireless communication interface, wherein the household appliance comprises the wired and/or wireless communication interface;
vi) intervening in a safety-related function of the household appliance; and
viii) requesting information collected by a sensor, wherein the household appliance comprises the sensor.

19. The method of claim 17, wherein controlling operation of the household appliance comprises controlling operation of a washing machine, a dryer, a dishwasher or a mobile appliance which may be placed in the washing machine, the dryer, or the dishwasher.

20. The method of claim 17, wherein generating the control parameter comprises generating the control parameter based at least in part on a user input.
